(19) United States
(12) Patent Application Publication
(10) Pub. No.: US 2014/0146662 A1
(43) Pub. Date: May 29, 2014

(54) MANAGEMENT SYSTEM AND MANAGEMENT METHOD

(71) Applicant: Hitachi, Ltd., Tokyo (JP)

(72) Inventors: Daisuke OKABE, Tokyo (JP); Akihiro KAMIYA, Tokyo (JP); Kota KAWAHARA, Tokyo (JP)

(73) Assignee: Hitachi, Ltd., Tokyo (JP)

(21) Appl. No.: 14/091,082

(22) Filed: Nov. 26, 2013

(30) Foreign Application Priority Data
Nov. 28, 2012 (JP) 2012-259600

(51) Int. Cl. H04L 12/24

(52) U.S. Cl. CPC H04L 41/0654
USPC 370/225

(57) ABSTRACT

Provided is a management system arranged to manage a plurality of network elements in a network. The management system specifies, when the management system receives an alarm event, a logical path corresponding to the received alarm event based on the logical path specifying information included in the received alarm event. The management system refers to the logical path management information and specifies an alarm spread logical path of the specified logical path. The management system correlate the received alarm event and the specified logical path, correlate the received alarm event and the specified alarm spread logical path, and register the correlations with the alarm spread logical path information.

### CLAIM OF PRIORITY

The present application claims priority from Japanese patent application JP2012-259600 filed on Nov. 28, 2012, the content of which is hereby incorporated by reference into this application.

### BACKGROUND

The present invention relates to a management system arranged to manage a plurality of network elements included in a network, and, in particular, to a management system arranged to manage abnormalities which are detected by the network elements.

A large scale carrier network includes a plurality of network elements and a management system (i.e., management server) arranged to manage the network elements. Since there is a plurality of logical paths which go through the plurality of network elements in such carrier network, when a failure occurs at one of the network elements within the network, multiple logical paths which go through the network element having the failure will be affected by the failure. When such occurrence is detected by the network element, an alarm event is transmitted to the management system. Since such failure in the logical path is detected also by another network element in the network which terminates the logical path, a large number of alarm events may be generated in response to the single failure, which makes it problematically difficult to identify the cause of the failure.

Also, due to growing size of network, configuring a network becomes further complicated since it is necessary to bundle an optical layer and a packet layer like an optical network, which bundles a large number of packet networks. Therefore, multiple steps will be required to appropriately grasp an area which is affected by the failure.

Japanese Unexamined Patent Application Publication No. H11-98140, and Japanese Unexamined Patent Application Publication No. 2009-246679 disclose the technical background related to the present technical field.

Japanese Unexamined Patent Application Publication No. H11-98140 discloses an alarm monitoring device 5 executes alarm collection based on master-slave communication. When a master interface part 2 detects a received (REC) alarm such as line disconnection, the device 5 specifies a slave interface 3 line-connected to the master interface part 2 through a time switch 4. Then the device 5 collects the alarm state of the specified slave interface part 3, and at the time of detecting a spread alarm such as an alarm indication signal (AIS) based on the REC alarm, masks the AIS. Consequently unnecessary spread alarms in a cross-connection device can be shrunk.

Japanese Unexamined Patent Application Publication No. 2009-246679 discloses that in a network including an integrated management device holding network configuration information and an integrated monitor device summarizing warning information, the integrated monitor device receives a warning about a fault, creates alarm information from the warning, acquires end-point information from the warning, inquires path information relating to the end-point information to the integrated management device, inquires a higher path and a lower path of the path information to the integrated management device, repeats imparting a fault cause flag to the alarm information by received warnings based on the higher path and the lower path, and specifies a basic cause of the fault from the fault cause flag in the alarm information.

### SUMMARY

Japanese Unexamined Patent Application Publication No. H11-98140 fails to disclose the correlation between the alarm event (causation alarm event) which notifies the cause of the failure and the alarm event (spread alarm even) which spreads as a result of the cause alarm event.

In Japanese Unexamined Patent Application Publication No. 2009-246679, while it is possible to correlate one piece of alarm information with another piece of alarm information by assigning a failure flag thereto, it is not possible to correlate the alarm information with its own logical path, making it difficult to identify the logical path of a given piece of causation alarm event as it spreads. To be more specific, in a multilayer network where logical paths having multiple layers exist, since the lower the layer of a logical path is the more of the upper layer of logical paths are accommodated therein, even when notification alarms are correlated with one another it remains difficult to identify the spreading range of the failure for a maintenance person 130 when the failure takes place in a lower logical path.

Thus, an object of the present invention is to provide a management system operable to correlate the alarm event and the logical path where the alarm event spreads.

A representative example of the present invention is a management system arranged to manage a plurality of network elements in a network. Each of the plurality of network elements includes a termination point which executes a process corresponding to a layer of communication. Logical paths each including, as components, termination points belonging to a layer are established among the plurality of network elements. A termination point transmits, when the termination point detects an abnormality within a logical path to which the termination point belongs, an alarm event including logical path specifying information operable to specify the logical path where the abnormality occurred to the management system. The management system includes logical path management information arranged to manage the logical paths, the termination points included in the logical paths, and layers of the logical paths, alarm spread logical path information arranged to manage a relationship of the alarm event and an alarm spread logical path indicated by the alarm event which transmits the alarm event as a result of spreading of the abnormality, and a processor. The processor specifies, when the management system receives an alarm event, a logical path corresponding to the received alarm event based on the logical path specifying information included in the received alarm event. The processor refers to the logical path management information and specifies an alarm spread logical path of the specified logical path. The processor correlates the received alarm event and the specified logical path, correlates the received alarm event and the specified alarm spread logical path, and registers the correlations with the alarm spread logical path information.

Below is a brief description of the exemplary effects obtained from the representative invention disclosed in this application. That is, it becomes possible to provide a management system operable to correlate an alarm event and a logical path where the alarm event spreads.

Subjects, configurations, and effects other than those stated above will be apparent from the following description of embodiments.

### BRIEF DESCRIPTION OF DRAWINGS

FIG. 1 is a schematic diagram illustrating a configuration of a network system according to an embodiment of the present invention.

FIG. 2 is a schematic diagram illustrating a relationship between a trail and a termination point according to an embodiment of the present invention.

FIG. 3 is a schematic diagram illustrating a port management table according to an embodiment of the present invention.

FIG. 4 is a schematic diagram illustrating a termination point management table according to an embodiment of the present invention.

FIG. 5 is a schematic diagram illustrating a trail management table according to an embodiment of the present invention.

FIG. 6 is a schematic diagram illustrating an alarm spread trail table according to an embodiment of the present invention.

FIG. 7 is a schematic flow chart illustrating an alarm confirmation process according to an embodiment of the present invention.

FIG. 8 is a schematic flow chart illustrating a spread alarm adding process according to an embodiment of the present invention.

FIG. 9 is a schematic flow chart illustrating a spread alarm deletion process according to an embodiment of the present invention.

FIG. 10 is a schematic diagram illustrating a termination point transmitting an alarm event when a failure occurred in a trail according to an embodiment of the present invention.

FIG. 11 is a schematic diagram illustrating an alarm spread trail table being updated by an alarm confirmation process according to an embodiment of the present invention.

FIG. 12 is a schematic diagram illustrating a trail display screen according to an embodiment of the present invention.

### DESCRIPTION OF EMBODIMENTS

Hereinafter, an embodiment of the present invention will be described in detail with reference to the drawings. Note that elements having features substantially the same will be assigned with same reference numbers and the description thereof will not be repeated.

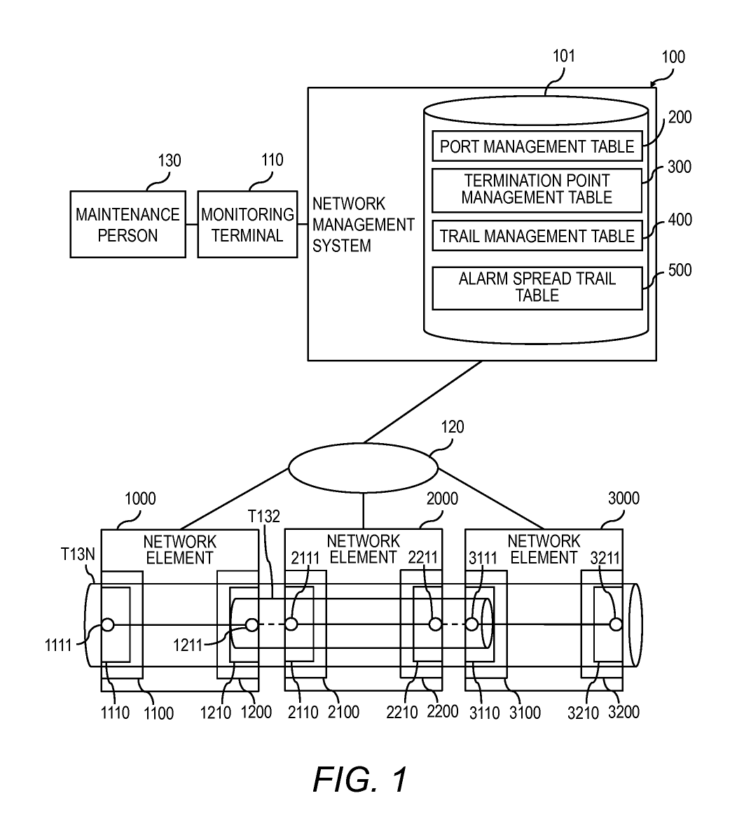

FIG. 1 is a schematic illustration illustrating a configuration of a network system according to the embodiment of the present invention.

The network system includes a network having network elements 1000, 2000 and 3000, a network management system 100, and a monitoring terminal 110 operated by a maintenance person 130. Note that in the description herein, the network elements 1000, 2000 and 3000 may generally be referred to as the network element.

The maintenance person 130 monitors the network elements 1000, 2000 and 3000, which configure the network, via a GUI monitor displayed on the monitoring terminal 110.

The network management system 100 is connected, via a monitoring network 120, to the network elements 1000, 2000 and 3000, which configure the network, manages and controls each of the network elements 1000, 2000 and 3000.

The network management system 100, which maybe, for example, a calculator of a server, or the like, and includes a database 101. The database 101 includes therein a port management table 200, a termination point management table 300, a trail management table 400, and an alarm spread trail table 500.

Note that although FIG. 1 illustrates the database 101 arranged in a same housing as the network management system 100, the database 101 may be arranged outside of the network management system 100.

A configuration of the network element will be described with the network element 1000 as an example thereof. The network element 1000 includes a plurality of interface cards 1100 and 1200 each arranged to communicate with the network elements 2000 and 3000. In a similar manner, the network elements 2000 and 3000 include interface cards 2100 and 2200, and interface cards 3100 and 3200, respectively. Note that in the description herein, the interface cards 1100, 1200, 2100, 2200, 3100, and 3200 may generally be referred to as the interface card.

Next, the interface card will be described with the interface card 1100 as an example thereof.

The interface card 1100 includes a communication port 1110 where the communication port 1110 includes a plurality of termination points 1111. The termination point 1111 executes, with respect to data received thereby, a process corresponding to its own layer. Note that the communication port 1110 executes a process corresponding to a lowest layer with respect to the received data. Thus, the communication port 1110 may be referred to as a termination point at a lowest layer.

A trail, which is a logical path at a common layer, is established when the termination points of a common layer are connected to one another among the plurality of network elements. According to FIG. 1, the termination points 1211, 2111, 2211 and 3311 are connected to one another, thereby establishing a trail T 132; and the termination points 1111, 1211, 2111, 2211, 3111 and 3211 are connected to one another, thereby establishing a trail T13N.

The tables 200 to 500 which are arranged in the database 101 will be briefly described.

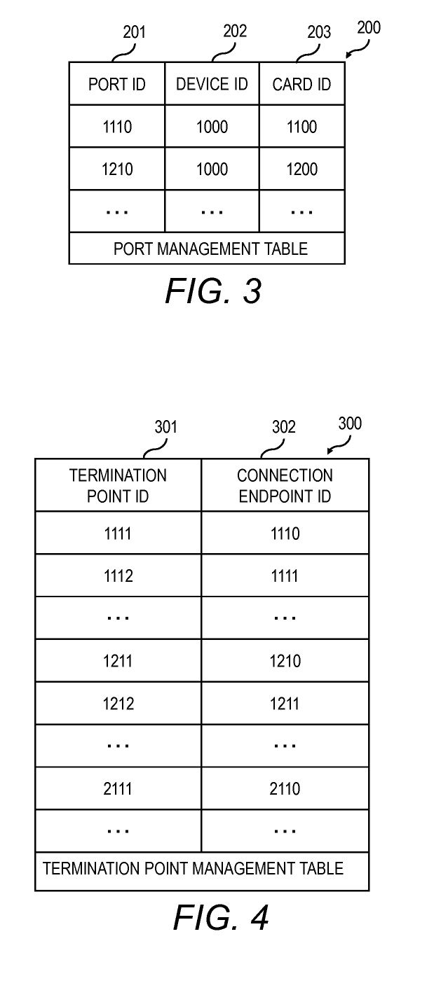

The port management table 200 is a table arranged to manage a relationship between the interface card included at the network element and a communication port included at said interface card. The port management table 200 will be described in detail with reference to FIG. 3.

The termination point management table 300 is a table arranged to manage a relationship between the termination point and a lower termination point connected to said termination point. The termination point management table 300 will be described in detail with reference to FIG. 4.

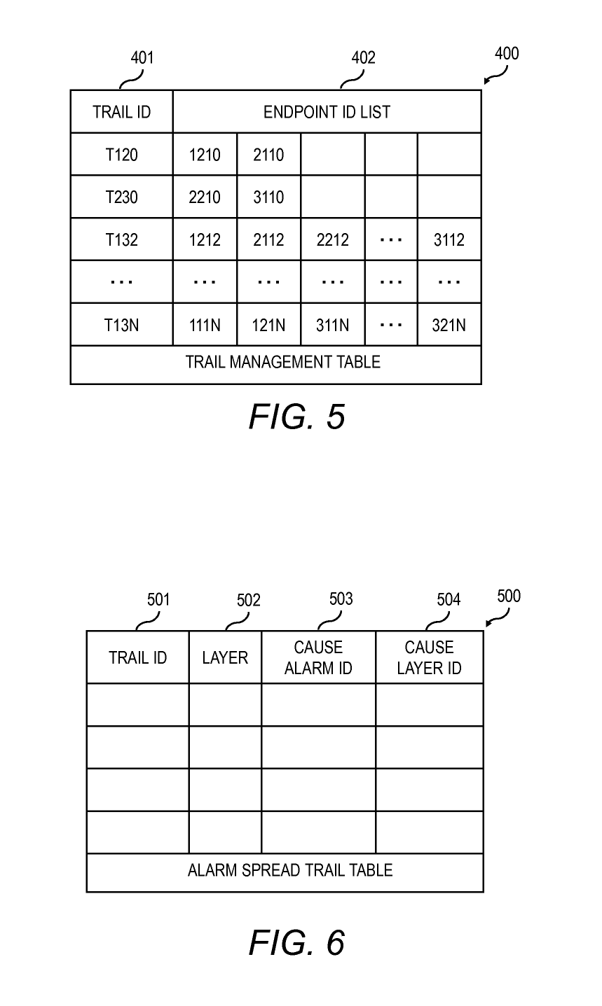

The trail management table 400 is a table arranged to manage a relationship between a trail and the termination point which is a component of said trail. The trail management table 400 will be described in detail with reference to FIG. 5.

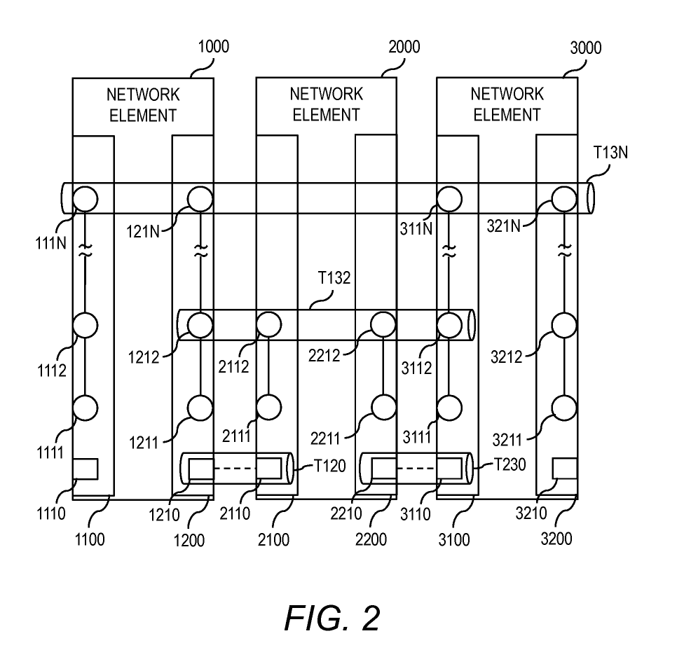

The alarm spread trail table 500 is a table arranged to manage a relationship between a logical path corresponding to an alarm event, which will be described in detail with reference to FIG. 2, and a logical path via which said alarm event spreads. The alarm spread trail table 500 will be described in detail with reference to FIG. 6.

It is to be appreciated that the number of network elements configuring the network, the number of interface cards included in the network elements, the number of communication ports included in the interface cards, and the number of termination points arranged at the communication ports are not limited to the number of the same as depicted in FIG. 1.

FIG. 2 is a schematic diagram illustrating a relationship between a trail and a termination point according to the embodiment of the present invention.

According to FIG. 2, the termination points 1111, 1112 and 111N are arranged above the communication port 1110 included in the interface card 1100 of the network element 1000; and the termination points 1211, 1212 and 121N are arranged above the communication port 1210 included in the interface card 1200 of the network element 1000.

Further, the termination points 2111 and 2112 are arranged above the communication port 2110 included in the interface card 2100 of the network element 2000; and the termination points 2211 and 2212 are arranged above the communication port 2210 included in the interface card 2200 of the network element 2000.

Further, the termination points 3111, 3112 and 311 N are arranged above the communication port 3110 included in the interface card 3100 of the network element 3000; and the termination points 3211, 3212 and 321N are arranged above the communication port 3210 included in the interface card 3200 of the network element 3000.

The trails T13N, T132, T120 and T230 are established among the network elements 1000, 2000 and 3000.

The trail T13N connects the network element 1000 and the network element 3000, and includes, as components thereof, the termination points 111N, 121N, 311N and 321N each at a layer N. The trail T132 connects the network element 1000 and the network element 3000, and includes, as components thereof, the termination points 1212, 2112, 2212 and 3112 each at a layer 2. The trail T120 connects the network element 1000 and the network element 2000, and includes, as components thereof, the communication ports 1210 and 2110 each at layer 0. The trail T230 connects the network element 2000 and the network element 3000, and includes, as components thereof, the communication ports 2210 and 3110 each at the layer 0.

Note that each reference numeral assigned to each trail will also be used as identification information of each trail in the description below. Further, it is to be noted that the last digit of each reference numeral assigned to each trail indicates a value specifying the layer of the trail. For example, the trail “T132” indicates that the layer of the trail is “2.”

Note that although FIG. 2 omits the illustration of termination points between a termination point at the layer 2 and a termination point at the layer N at the network element 1000 and the network element 3000, a plurality of termination points may be arranged between such points.

FIG. 3 is a schematic diagram illustrating the port management table 200 according to the embodiment of the present invention.

As described above with FIG. 1, the port management table 200 is a table arranged to manage the relationship between the interface card of the network element and the communication port of the interface card. The port management table 200 is prefixed by the maintenance person 130 and/or an administrator, for example.

The port management table 200 includes a port ID 201, a device ID 202 and a card ID 203.

The port ID 201 registers therein an identifier of a communication port. It is to be noted that although FIG. 3 illustrates the identifiers for the communication ports which are identical as the reference numerals assigned to the communication ports illustrated in FIG. 1 and FIG. 2, the present invention is not limited thereto.

The device ID 202 registers therein an identifier of a network element. It is to be noted that although FIG. 3 illustrates the identifiers of the network elements which are identical as the reference numerals assigned to the network elements illustrated in FIG. 1 and FIG. 2, the present invention is not limited thereto.

The card ID 203 registers therein an identifier of the interface card included in the network element. It is to be noted that although FIG. 3 illustrates the identifier of the interface card which are identical as the reference numerals assigned to the interface cards illustrated in FIG. 1 and FIG. 2, the present invention is not limited thereto.

In a manner described above, the port management table 200 manages the relationship among the communication port, the interface card including said communication port, and the network element including said interface card.

FIG. 4 is a schematic diagram illustrating the termination point management table 300 according to the embodiment of the present invention.

As described above with FIG. 1, the termination point management table 300 is a table arranged to manage the relationship between the termination point and a lower termination point connected to said termination point. The termination point management table 300 is prefixed by the maintenance person 130 and/or an administrator, for example.

The termination point management table 300 includes a termination point ID 301 and a connection endpoint ID 302.

The termination point ID 301 registers therein an identifier of a termination point. The connection endpoint ID 302 registers therein an identifier of the lower termination point connected to the termination point which is identified by the identifier registered with the termination point ID 301; that is to say, the identifier of the termination point, which accommodates therein the termination point identified by the identifier registered with the termination point ID 301, is registered with the connection point endpoint ID 302.

For example, in an ATM, when the identifier of a VC termination point is registered with the termination point ID 301, a VP termination point is registered with the connection endpoint ID 302 of such record.

It is to be noted that although FIG. 4 illustrates the identifiers of the termination points registered with the termination point ID 301 and the connection endpoint ID 302 which are identical as the reference numerals assigned to the termination points illustrated in FIG. 1 and FIG. 2, the present invention is not limited thereto.

FIG. 5 is a schematic diagram illustrating the trail management table 400 according to the embodiment of the present invention.

As described above with FIG. 1, the trail management table 400 is a table arranged to manage the relationship between a trail and the termination point which is a component of said trail. The trail management table 400 is prefixed by the maintenance person 130 and/or an administrator, for example.

The trail management table 400 includes a trail ID 401 and an endpoint ID list 402.

The trail ID 401 registers therein an identifier of a trail. The endpoint ID list 402 registers therein an identifier of the termination point which is a component of the trail.

Note that the identifiers of the trails are identical as the reference numerals assigned to the trails illustrated in FIG. 1 and FIG. 2, and include the layer identifier which identifies the layer of each trail. Thus, the last digit of each trail's identifier identifies the layer of said trail. Accordingly, the trail management table 400 is a table arranged to manage the relationship among the trail, the termination point configuring said trail, and the layer of said trail.

Note that when an identifier, which does not include the layer identifier, is used, the trail management table 400 further includes (a column for) a layer, in which the layer registers therein the trail's layer identifier.

FIG. 6 is a schematic diagram illustrating the alarm spread trail table 500 according to the embodiment of the present invention.

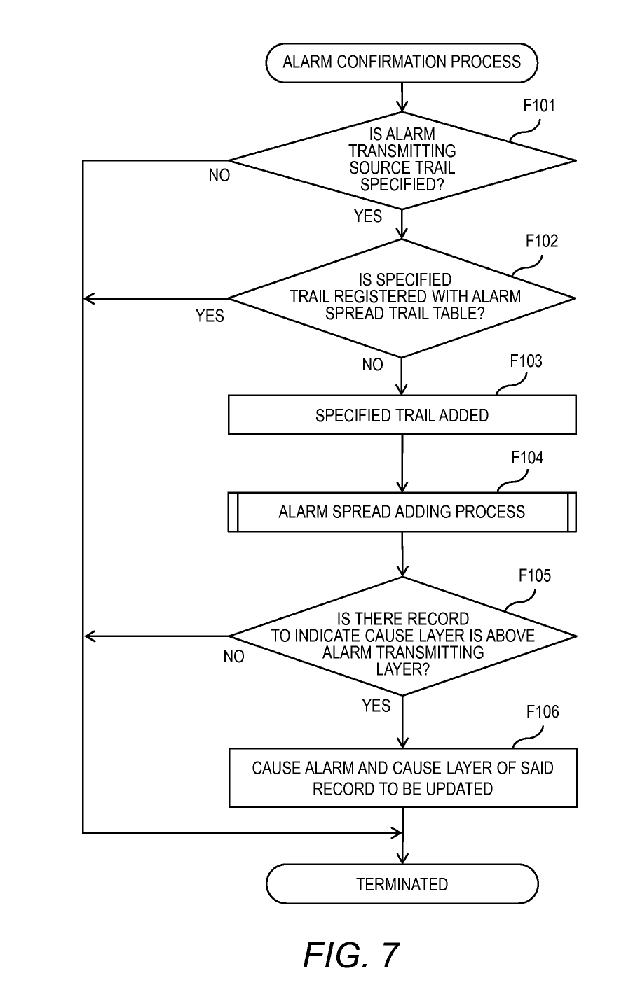

As described above with FIG. 1, the alarm spread trail table 500 is a table arranged to manage the relationship between the logical path corresponding to an alarm event and the logical path via which said alarm event spreads. The alarm spread trail table 500 is updated via an alarm confirmation process, which is executed when the network management system 100 receives an alarm event. The alarm confirmation process will be described below with reference to FIG. 7.

The alarm spread trail table 500 includes a trail ID 501, a layer 502, a cause alarm ID 503, and a cause layer 504.

The trail ID 501 registers therein an identifier of the trail which will be affected by a failure, which occurred. The layer 502 registers therein an identifier of a layer of a trail which is identifiable by an identifier registered with the trail ID 501. The cause alarm ID 503 registers therein an identifier of an alarm event (cause alarm event) which is determined, by an identifier registered with the trail ID 501, to be a cause affecting a trail. The cause layer 504 registers therein an identifier of a layer of a trail (i.e., a trail where the failure occurred) of which the termination point, which transmits the cause alarm, is a component.

Note that the trail which will be affected by a failure, which occurred, is a trail which includes, as a component thereof, the terminal which transmits the alarm event, or a trail (alarm spread trail) which includes, as a component thereof, the termination point which transmits an alarm event as a consequence of said alarm event spreading.

Since a trail in an upper layer is accommodated in a lower layer, when a failure (cause failure) occurs at a trail in a lower layer, due to the cause failure, another failure (spread failure) occurs at a trail in a layer above the layer in which the original failure took place. Accordingly, an alarm event will be transmitted from a termination point at a trail in a layer above the layer in which the cause failure took place.

Further, note that when an identifier of a trail includes an identifier of a layer, the column for layer 502 will be unnecessary.

Further, note that when a failure takes place within a trail, the termination point at either end of said trail will transmit an alarm event, therefore, the alarm spread trail table 500 may include multiple cause alarm IDs 503 and cause layers 504.

It is to be noted that the tables, which are described above with reference to FIG. 3 to FIG. 6, may include columns other than what are illustrated in the drawings, or may be in a form other than a table form such as a list.

FIG. 7 is a schematic flow chart illustrating the alarm confirmation process according to the embodiment of the present invention.

The alarm confirmation process executed by a CPU (not illustrated in the drawings) in the network management system 100 is a process arranged to update, when the network management system 100 receives an alarm event, the alarm spread trail table 500 based on the received alarm event.

Before describing the alarm confirmation process in detail, the alarm event will be described below. The alarm event is transmitted to the network management system 100 by the network element to which the termination point, which detects a failure, belongs. The alarm event includes trail specification information, which specifies the trail to which the termination point, which is the source transmitter thereof, belongs and an identifier of said alarm event. The trail specification information may be, for example, an identifier of the termination point, or an identifier of the trail to which the termination point, which is the source transmitter, belongs.

Firstly, when the network management system 100 receives an alarm event, the network management system 100 specifies, based on the trail specification information included in the received alarm event, the trail to which the termination point, which transmitted the alarm event, belongs. That is to say, the network management system 100 specifies the trail corresponding to the alarm event (F101).

A process carried out at F101 will be described below in detail. When the trail specification information included in the alarm event is an identifier of a trail, the network management system 100 specifies the trail identified by the identifier thereof as the trail corresponding to the alarm event.

On the other hand, when the trail specification information included in the alarm event is an identifier of a termination point, the network management system 100 refers to the trail management table 400 to acquire an identifier of a trail registered with the trail ID 401 from a record indicating that the identifier matching with the identifier of the termination point is registered with the end point ID list 402. Further, the network management system 100 specifies the trail whose identifier is identified via the acquired trail's identifier as the trail corresponding to the alarm event.

Next, the network management system 100 makes a determination as to whether or not the trail specified in the process F101 is registered with the alarm spread trail table 500 (F102). To be more specific, the network management system 100 makes a determination as to whether or not the identifier of the trail corresponding to the received alarm event is registered with the trail ID 501 of the alarm spread trail table 500.

When it is determined in the process F102 that the trail corresponding to the received alarm event is not registered with the trail table 500, the network management system 10 determines that the received alarm event is a new cause alarm, correlates the received alarm event with the trail corresponding to said alarm event, and registers such correlation with the trail table 500 (F103).

To be more specific, the network management system 100 adds a record to the alarm spread trail table 500 and registers the identifier of the trail which is specified in the process F101 with the trail ID 501 of said record. Further, the network management system 100 registers, with the layer 502 of the added record, the identifier of the layer of the trail which is specified by the last digit of the identifier of the trail specified in the process F101. Further, the network management system 100 registers, with the cause alarm ID 503 of the added record, the identifier of the alarm event, which is included in said received alarm event. Further, the network management system 100 registers, with the cause layer 504 of the added record, the identifier of the trail specified by the last digit of the identifier specified in the process F101. Accordingly, the alarm spread trail table 500 registers therein the received alarm event and the trail corresponding to said alarm event in a correlated manner.

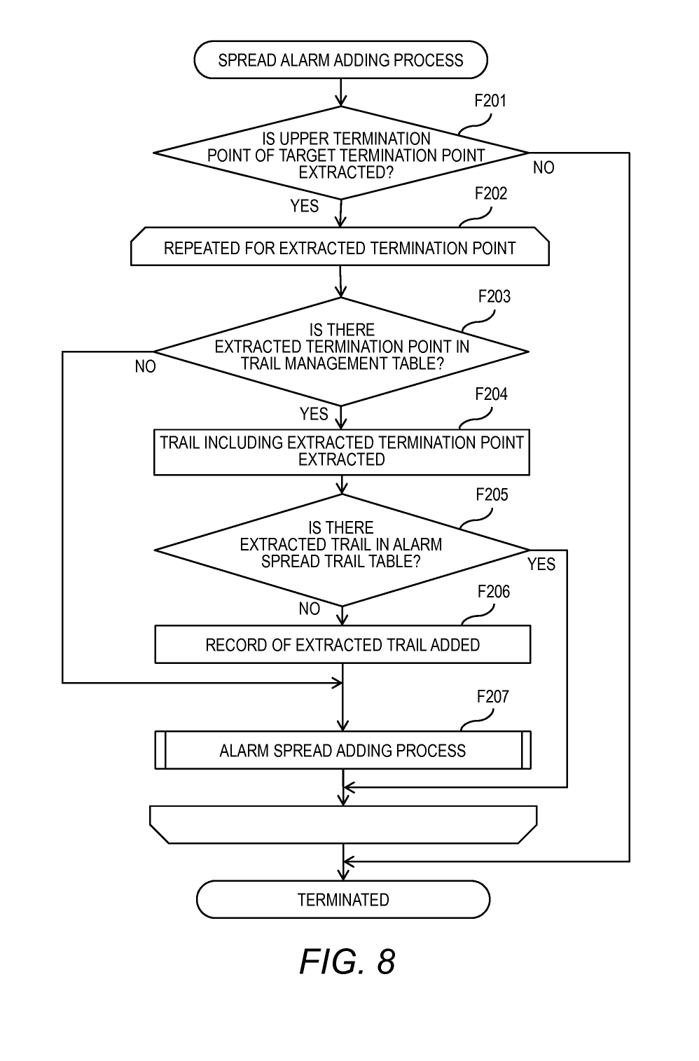

Next, the network management system 100 executes a spread alarm adding process which is a process to correlate the received alarm event with the trail where said alarm event spreads, and register such correlation with the alarm spread trail table 500 (F104). The spread alarm adding process will be described below in detail with reference to FIG. 8.

Next, the network management system 100 makes a determination as to whether or not the cause layer 504 of the alarm spread trail table 500 includes a record of a layer above the layer of the trail specified in the process F101 (F105).

When it is determined in the process F105 that the cause layer 504 of the alarm spread trail table 500 includes the record of the layer above the layer of the trail specified in the process F101, the network management system 100 determines that the distance between the alarm event currently received is nearer to the layer in which the cause failure took place than the alarm event correlated to the trail of said record is to said layer. Further, the network management system 100 overwrites existing information with the identifier of the alarm event included in the received alarm event at the cause alarm ID 503 of said record, and overwrites existing information with the layer of the trail corresponding to the received alarm event at the cause layer 504 of said record (F106) in order to complete the process.

In other words, when it is determined in the process F105 that the cause layer 504 of the alarm spread trail table 500 includes the record of the layer which is above another layer of the trail specified in the process F101, the network management system 100 determines that the network management system 100 has received an alarm event which is originated from a source nearer to the cause failure than the alarm event which had been received previously by the network management system 100, and updates the alarm spread trail table 500 such that the trail, which is correlated to the alarm event previously received, is correlated to the currently received alarm event.

On the other hand, when it is determined in the process F102 that the trail specified in the process F101 is already registered with the alarm spread trail table 500, or when it is determined in the process F105 that the cause layer 504 of the alarm spread trail table 500 does not include the record of the registration of the layer which is above the layer of the trail specified in the process F101, the process is terminated.

FIG. 8 is s a schematic flow chart illustrating the spread alarm adding process according to the embodiment of the present invention.

The spread alarm adding process is a process to correlate the trail, which includes the termination point transmitting the alarm event as a result of the spreading of the failure indicated by the received alarm event, with the received alarm event, and registers such correlation with the alarm spread trail table 500.

Firstly, the network management 100 refers to the termination point management table 300 in order to determine as to whether or not it is possible to extract the termination point (hereinafter, “upper termination point”) of the layer which is above the layer of the termination point included in the trail specified in the process F101 as illustrated in FIG. 7 (F201). To be more specific, the network management system 100 makes a determination as to whether or not the termination point management table 300 includes a record indicating that an identifier, which matches with an identifier of the termination point included in the trail which is specified in the process F101, is registered with the connection endpoint ID 302. Note that when it is determined that such record is included in the termination point management table 300, the network management system 100 extracts the termination point, which is specified by the identifier registered with the termination point ID 301 of said record, as the upper termination point.

When it is determined in the process F201 that the network management system 100 is able to extract the upper termination point, the network management system 100 selects a termination point, out of the termination points extracted in the process F201, as a process target termination point, and executes the processes F203 to F207 to the process target terminal, wherein the network management system 100 repeats the processes F203 to F207 until the processes F203 to F207 are executed to each termination point that is extracted in the process F201 (F202).

When the process target termination point is selected in the process F202, the network management system 100 makes a determination as to whether or not the end point ID list 402 of the trail management table 400 includes the registration of the process target termination point (F203).

When it is determined in the process F203 that the end point ID list 402 of the trail management table 400 includes the registration of the process target termination point, the network management system 100 extracts the trail which is specified by its identifier registered with the trail ID 401 from the record indicating the registration of the process target termination point with the end point ID list 402 of the trail management table 400 (F204).

On the other hand, when it is determined in the process F203 that the end point ID list 402 of the trail management table 400 does not include the registration of the process target termination point, the processes of F203 to F206 will not be executed.

Next, the network management system 100 makes a determination as to whether or not the trail, which is extracted in the process F204, is registered with the alarm spread trail table 500 (F205).

When it is determined in the process F205 that the trail, which is extracted in the process F204, is not registered with the alarm spread trail table 500, the network management system 100 registers the trail extracted in the process F204 with the alarm spread trail table 500 (F206). To be more specific, the network management system 100 adds a new record to the alarm spread trail table 500, registers an identifier of the trail extracted in the process F204 with the trail ID 501 of the newly added record, registers the last digit of the identifier of the trail extracted in the process F204 with the layer 502 of the newly added record, registers the identifier of the alarm event included in the received alarm event with the cause alarm ID 503 of the newly added record, and registers the layer of the trail corresponding to the received alarm event with the cause layer 504 of the newly added record.

Next, the network management system 100 executes the spread alarm adding process in a recursive manner with respect to the process target termination point which is selected in the process F202 (F207).

After the execution of the process F206, or when it is determined in the process F205 that the alarm spread trail table 500 includes the registration of the trail which is extracted in the process F204, the network management system 100 makes a determination as to whether or not the processes F203 to F207 have been executed to each termination point extracted in the process F201. When it is determined that the processes F203 to F207 have been executed to each termination point extracted in the process F201, the spread alarm adding process is terminated. When it is determined that the processes F203 to F207 have not been executed to each termination point extracted in the process F201, the process goes back to F202, and a termination point to which the processes F203 to F207 have not been executed will be selected as a process target termination point.

When it is determined in the process F201 that the upper termination point is not extractable, the spread alarm adding process is terminated.

By the process described above, the network management system 100 is able to correlate an alarm event and the logical path via which said alarm event spreads, and retain such correlation information at the alarm spread trail table 500.

Further, when it is determined in the process F102 that the alarm spread trail table 500 does not include the registration of the trail which is specified in the process F101, the network management system 100 executes an alarm spread adding process in the process F104. By executing the alarm spread adding process, it becomes possible, before receiving the spreading alarm event caused by the alarm event, to correlate the received alarm event with the trail which includes the termination point transmitting the alarm event as a result of the spreading of the alarm event, and retain such correlation at the alarm spread trail table 500. Further, since it becomes possible to eliminate the need to update the alarm spread trail table 500 each time an alarm event is received, the processing load imposed on the network management system 100 will be reduced.

Further, when it is determined in the process F105 that the cause layer 504 of the alarm spread trail table 500 includes a record of the registration of the layer which is above the layer of the trail specified in the process F101, the network management system 100, via the process F106, updates the alarm spread trail table 500 such that the trail of said record and the currently received alarm event are correlated with one another. By the virtue of such process, in a case where an alarm event is received from a trail, in which the cause failure is spread, before an alarm event, which is transmitted from the trail in which the cause failure took place, is received, it become possible to correlate the alarm event, which is transmitted from the trail nearer to the cause failure, and the trail.

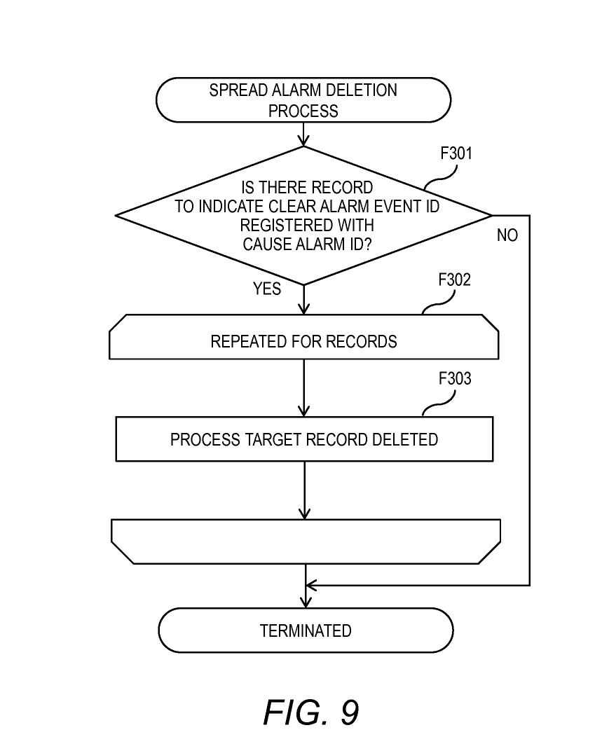

FIG. 9 is a schematic flow chart illustrating a spread alarm deletion process according to the embodiment of the present invention.

The spread alarm deletion process is executed by a CPU (not illustrated in the drawings) of the network management system 100 when the network management system 100 receives a clear alarm event (deletion alarm event).

Hereinafter, the clear alarm event will be described. The clear alarm event is transmitted to the network management system 100 when a termination point, which previously detected a failure, detects a recovery from the failure. The clear alarm event includes the trail specification information, and a clear alarm event identifier, which is an identifier identical to an identifier included in the alarm event, which was transmitted based on the failure which is now recovered.

Firstly, the network management system 100 makes a determination as to whether or not the alarm spread trail table 500 includes a record indicating an identifier, which is registered with the cause alarm ID 503 of the alarm spread trail table 500, matches with the clear alarm event identifier included in the received clear alarm event received (F301).

When it is determined in the process F301 that the alarm spread trail table 500 includes the record indicating that the identifier registered with the cause alarm ID 503 of the trail spread trail table 500 matches with the clear alarm event identifier included in the received clear alarm event, the network management system 100 selects, out of a record indicating that the identifier registered with the cause alarm ID 503 matches with the clear alarm event identifier included in the received clear alarm event, a record to which the process F303 has not been executed as a process target record, and executes, in a repeated manner, the process F303 to each record, indicating that the identifier registered with the cause alarm ID 503 matches with the clear alarm event identifier included in the received clear alarm event (F302).

The network management system 100 deletes the process target record (F303). Then, when the process F303 is executed to each record, indicating that the identifier registered with the cause alarm ID 503 matches with the clear alarm event identifier included in the received clear alarm event, the network management system 100 terminates the process; and when the process F303 is not yet executed to each record, indicating that the identifier registered with the cause alarm ID 503 matches with the clear alarm event identifier included in the received clear alarm event, the network management system 100 returns to the process F302.

Accordingly, in a case where the failure is recovered, the correlation between the alarm event, originated from the failure which has been recovered, and the trail corresponding to said alarm event will be deleted.

Further, when it is determined in the process F301 whether or not the alarm spread trail table 500 includes a record, indicating that the identifier registered with the cause alarm ID 503 of the alarm spread trail table 500 matches with the clear alarm event identifier included in the received clear alarm event, and only when it is determined that such record is included in the alarm spread trail table 500, the process moves on beyond F302. By virtue of such procedure, compared with a procedure where it is determined for each record, included in the alarm spread trail table 500, as to whether or not an identifier registered with the cause alarm ID 503 matches with the clear alarm event identifier included in the received clear alarm event, and the record indicating such match is deleted, the processing load imposed on the network management system 100 will be reduced.

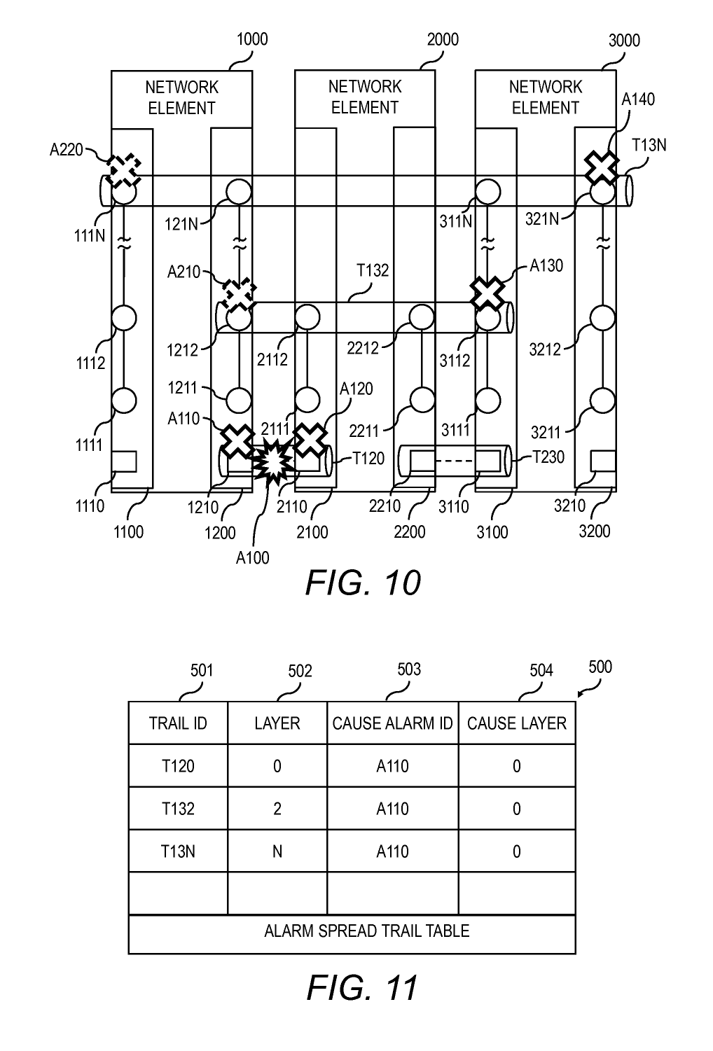

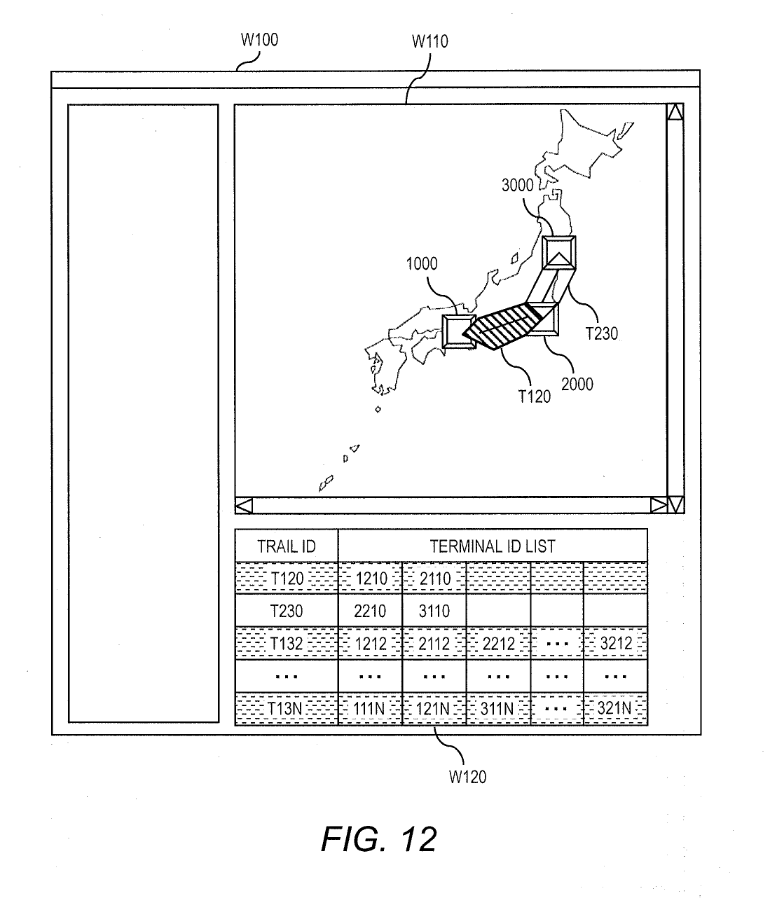

The alarm confirmation process which is executed in a case where a failure occurs in the trail T120 will be described with reference to FIG. 10 and FIG. 11.

FIG. 10 is a schematic diagram illustrating a termination point transmitting an alarm event when a failure occurred in the trail T120 according to the embodiment of the present invention.

When a failure A100 occurs in the trail T120, the communication ports 1210 and 2210, which are anchors of the trail T120, detect the failure A100, and transmit alarm events A110 and A120 to the network management system 100, respectively.

Further, the termination points 1212 and 3112, which are anchors of the trail T132 accommodated in the trail T120 (in other words, the trail T132 which goes through the trail T120), each detect the failure. The termination point 3112 transmits an alarm event A130 to the network management system 100. In the network element 1000 which includes the terminal 1212, since the communication port 1210 has already transmitted the alarm event A110, the termination point 1212 will not transmit an alarm event A210 to the network management system 100 even though the termination point 1212 detects the failure. Such process is referred to as a mask processing.

Further, although the termination point 111N, which is an anchor of the trail T13N accommodated in the trail T132, detects the failure, by virtue of the mask processing, the termination point 111N will not transmit an alarm event A220 to the network management system 100.

Further, the termination point 321N, which is an anchor of the trail T13N accommodated in the trail T132, detects the failure and transmits an alarm event A140 to the network management system 100 without executing the mask processing. This aspect of the procedure will be described. According to FIG. 10, the network element 1000 transmits data to the network element 3000 wherein the alarm event A130, which is transmitted by the termination point 3112 included in the network element 3000 which is a data recipient, is a so called backward failure event which is not a subject to the mask processing. Accordingly, the termination point 321N transmits the alarm event A140 even though the alarm event A130 has already been transmitted in the network element 3000.

Note that the mask processing according to the present embodiment may be such that when a termination point, which is included in a network element on a data transmission side, transmits an alarm event (i.e., forward failure event), another termination point within said network element is designed not to transmit any alarm event.

It is to be noted that the network management system 100 is the first to receive the alarm event A110 transmitted by the communication port 1210.

Upon receiving the alarm event A110, the network management system 100 executes the alarm confirmation process illustrated in FIG. 7. Hereinafter, the alarm spread trail table 500, which will be updated by the alarm confirmation process when the alarm event A110 is received, will be described with reference to FIG. 11. FIG. 11 is a schematic diagram illustrating the alarm spread trail table 500 being updated by the alarm confirmation process according to the embodiment of the present invention.

Firstly, the network management system 100, via the process F101, specifies, based on the trail specification information included in the alarm event A110, the trail T120, which corresponds to the alarm event A110.

Next, the network management system 100 determines, via the process F102, that the trail T120 is not registered with the alarm spread trail table 500, and proceeds to the process F103. In the process F103, the network management system 100 registers “T120” under the trail ID 501 as illustrated in the first column of the alarm spread trail table 500 in FIG. 11, registers “0” under the layer 502, registers “A110” under the cause alarm ID 503, and registers “0” under the cause layer 504.

Next, the network management system 100 executes the alarm spread adding process via the process F104. The alarm spread adding process will be described with reference to FIG. 8.

In the process F201, since the termination point management table 300 includes a record indicating that the termination point “1210” which is a source of the alarm event A110 is registered with the connection endpoint ID 302 of the termination point management table 300, the network management system 100 extracts the “1211” which is registered with the termination point ID 301 of said record as an upper termination point, and proceeds to the process F202.

In the process F202, the network management system 100 selects the termination point “1211” as a process target termination point, and executes the processes F203 to F207 to the same.

In the process F203, since the termination point “1211” is not registered with the end point ID list of the trail management table 400, the network management system 100 proceeds to the process F207, and executes the alarm spread adding process.

Hereinafter, a first alarm spread adding process, which is executed in the process F207, will be described.

In the process F201, since the termination point management table 300 includes the record, indicating that the termination point “1211” is registered with the connection endpoint ID 302 of the termination point management table 300, the network management system 100 extracts the “1212” which is registered with the termination point ID 301 of said record as the upper termination point, and proceeds to the process F202.

In the process F202, the network management system 100 selects the termination point “1212” as the process target terminal, and executes the processes F203 to F207 to the same.

In the process F203, since the termination point “1212” is registered with the record of the trail T132 in the end point ID list of the trail management table 400, the process proceeds to the process F204.

In the process F204, the network management system 100 extracts the trail T132, in which the termination point “1212” is registered, from the trail management table 400.

In the process F205, since the extracted trail T132 is not registered with the alarm spread trail table 500, the process proceeds to the process F206.

In the process F206, the network management system 100 registers “T132” under the trail ID 501 as illustrated in the first column of the alarm spread trail table 500 in FIG. 11, registers “2” under the layer 502, registers “A110” under the cause alarm ID 503, registers “0” under the cause layer 504, and proceeds to the process F207 in order to execute the alarm spread adding process.

In a second alarm spread adding process, the processes F202 to F207 are executed to a termination point which is above the termination point “1212.”

Accordingly, since the alarm spread adding process is executed in a recursive manner, it becomes possible, upon receiving the alarm event A110, to correlate the trails “T132” and “T13N,” which are accommodated in a trail corresponding to said alarm event A110, with said alarm event A110, and register such correlation with the alarm spread trail table 500.

By virtue of such process, the maintenance person 130 is able to grasp the trail via which the alarm event A110 spreads before the transmission of an alarm event from a termination point in the trail T132 and an alarm event from a termination point in the trail T13N.

FIG. 12 is a schematic diagram illustrating a trail display screen W 100 according to the embodiment of the present invention.

The trail display screen W 100 is a screen displayed on the monitoring terminal 110 when the network management system 100 receives an alarm event, or when the network management system 100 receives a display request from the maintenance person 130 via the monitoring terminal 110.

The trail display screen W 100 includes a graphical display area W 110, and a list display area W 120.

The list display area W 120 displays a trail, which is registered with the trail management table 400. Note that the trail, which is displayed on the list display area W 120 and which is also registered with the alarm spread trail table 500, may be displayed with, for example, a shade over it in order to make said trail visually distinguishable, for the maintenance person 130, as a trail with a failure which has occurred or will occur.

The graphical display area W 110 displays a map indicating the trail, which is selected in the list display area W 120. Note that in a case where the trail, which is selected in the list display area W 120 and which is also registered with the alarm spread trail table 500, said trail is displayed with, for example, a shade over it in order to make said trail visually distinguishable, for the maintenance person 130, as a trail with a failure which has occurred or will occur.

It is to be noted that the trail display screen W 100 may additionally include information which is registered in tables other than what is described above in a different form.

As described above, according to the present invention, since it is possible to manage the alarm event, which is transmitted when a failure occurs, and the trail, via which said failure spreads, in a correlated manner, it becomes possible to clearly indicate to the maintenance person 130 the area affected by said failure in units of layers within the trail.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card. The drawings shows control lines and information lines as considered necessary for explanation but do not show all control lines or information lines in the products. It can be considered that almost of all components are actually interconnected.

What is claimed is:

1. A management system arranged to manage a plurality of network elements in a network,
wherein each of the plurality of network elements includes a termination point which executes a process corresponding to a layer of communication,
wherein logical paths each including, as components, termination points belonging to a layer are established among the plurality of network elements,
wherein a termination point transmits, when the termination point detects an abnormality within a logical path to which the termination point belongs, an alarm event including logical path specifying information operable to specify the logical path where the abnormality occurred to the management system, and
the management system comprising:
logical path management information arranged to manage the logical paths, the termination points included in the logical paths, and layers of the logical paths;
alarm spread logical path information arranged to manage a relationship of the alarm event and an alarm spread logical path indicated by the alarm event which transmits the alarm event as a result of spreading of the abnormality; and
a processor configured to:
specify, when the management system receives an alarm event, a logical path corresponding to the received alarm event based on the logical path specifying information included in the received alarm event,
refer to the logical path management information and specify an alarm spread logical path of the specified logical path; and
correlate the received alarm event and the specified logical path, correlate the received alarm event and the specified alarm spread logical path, and register the correlations with the alarm spread logical path information.

2. The management system according to claim 1, wherein the processor is configured to:
determine, when the logical path of the received alarm event is specified, whether or not the specified logical path is registered with the alarm spread logical path information;
correlate the received alarm event and the specified logical path, and register the correlation with the alarm spread logical path information when the specified logical path is not registered with the alarm spread logical path information;
specify the layer of the logical path corresponding to the received alarm event,
refer to the logical path management information and specify the logical path of a layer above the specified layer as the alarm spread logical path; and
correlate the received alarm event and the specified alarm spread logical path, and registers the correlation with the alarm spread logical path information.

3. The management system according to claim 2, wherein the processor is configured to update, after the received alarm event and the specified alarm spread logical path are correlated and registered with the alarm spread logical path information, and when the alarm spread logical path information includes another logical path correlated to another alarm event corresponding to another logical path of the layer above the logical path corresponding to the received alarm event, the alarm spread logical path information to correlate the received alarm event and the another logical path.

4. The management system according to claim 1,
wherein the termination point transmits, when the termination point detects a recovery from the abnormality, a deletion alarm event including an alarm event specifying information operable to specify the alarm event transmitted when the termination point detected the abnormality, to the management system, and
wherein the processor is configured to delete, when the management system receives the deletion alarm event, a correlation of the alarm event specified by the alarm event specifying information included in the received deletion alarm event and the logical path, from the alarm spread logical path information.

5. A management method of the network element for a management system arranged to manage a plurality of network elements in a network,
wherein each of the the plurality of network elements includes a termination point arranged to execute a process corresponding to a layer of a communication,
wherein logical paths each including, as components thereof, termination points belonging to a layer, are established among the plurality of network elements,
wherein a termination point transmits, when the termination point detects an abnormality within a logical path to which the termination point belongs, an alarm event, including logical path specifying information operable to specify the logical path the abnormality occurred, to the management system, and
wherein the management system retains logical path management information arranged to manage logical paths, termination points included in the logical paths, and layers of the logical paths, and alarm spread logical path information arranged to manage a relationship of the alarm event and an alarm spread logical path indicated by the alarm event which transmits the alarm event as a result of a spreading of the abnormality, and
the management method comprising:
specifying, by the management system, when the management system receives an alarm event, a logical path corresponding to the received alarm event based on the logical path specifying information included in the received alarm event,
referring, by the management system, to the logical path management information and specifying an alarm spread logical path of the specified logical path, and
correlating, by the management system, the received alarm event and the specified logical path, correlating the received alarm event and the specified alarm spread logical path, and registering the correlation with the alarm spread logical path information.

6. The management method according to claim 5, further comprising:
determining, by the management system, when the logical path of the received alarm event is specified, whether or not the specified logical path is registered with the alarm spread logical path information:
correlating, by the management system, the received alarm event and the specified logical path and registering the correlation with the alarm spread logical path information when the specified logical path is not registered with the alarm spread logical path information, and registering the correlation with the alarm spread logical path information;
specifying, by the management system, the layer of the logical path corresponding to the received alarm event;
referring, by the management system, to the logical path management information and specifying the logical path of a layer above the specified layer as the alarm spread logical path; and
correlating, by the management system, the received alarm event and the specified alarm spread logical path, and registering the correlation with the alarm spread logical path information.

7. The management system according to claim 6, further comprising updating, by the management system, after the received alarm event and the specified alarm spread logical path are correlated and registered with the alarm spread logical path information, and when the alarm spread logical path information includes another logical path correlated to another alarm event corresponding to another logical path of the layer above the logical path corresponding to the received alarm event, the alarm spread logical path information to correlate the received alarm event and the another logical path.

8. The management method according to claim 5,
wherein the termination point transmits, when the termination point detects a recovery from the abnormality, a deletion alarm event including alarm event specifying information operable to specify the alarm event transmitted when the termination point detected the abnormality, to the management system, and
the management method further comprising deleting, by the management system, when the management system receives the deletion alarm event, a correlation of the alarm event specified by the alarm event specifying information included in the received deletion alarm event and the logical path, from the alarm spread logical path information.
